(19) United States
(12) Patent Application Publication
(10) Pub. No.: US 2014/0234635 A1
(43) Pub. Date: Aug. 21, 2014

(54) ANTIFOULING FILM-COATED SUBSTRATE AND PROCESS FOR ITS PRODUCTION

(71) Applicant: ASAHI GLASS COMPANY, LIMITED, Chiyoda-ku (JP)

(72) Inventors: Yasuhiko AKAO, Tokyo (JP); Gousuke Yoshida, Tokyo (JP)

(73) Assignee: ASAHI GLASS COMPANY, LIMITED, Chiyoda-ku (JP)

(21) Appl. No.: 14/259,493

(22) Filed: Apr. 23, 2014

Related U.S. Application Data
(63) Continuation of application No. PCT/JP2012/083351, filed on Dec. 21, 2012.

(30) Foreign Application Priority Data
Dec. 28, 2011 (JP) 2011-287484

(51) Int. Cl. C03C 17/30

(52) U.S. Cl. CPC C03C 17/30; C03C 2217/70
USPC 428/447; 427/299; 427/539

(57) ABSTRACT

To provide an antifouling film-coated substrate, which has a fluorinated organic silicon compound coating film and which is excellent in the antifouling properties as it has water repellency, oil repellency, etc. and also excellent in the abrasion resistance so that deterioration in the antifouling properties is prevented against repeated wiping operations. The antifouling film-coated substrate 3 comprises a transparent substrate 1 having a film-forming surface 1a exposed to at least a moisture-containing atmosphere, and a fluorinated organic silicon compound coating film 2 formed on the film-forming surface 1a of the transparent substrate 1 by a dry-mode method.

### TECHNICAL FIELD

The present invention relates to an antifouling film-coated substrate and a process for its production.

### BACKGROUND ART

A touch panel which is used for a smartphone, a tablet PC, etc., is likely to be stained by a finger print, sebum, sweat, etc. as it is touched by a human finger during its use. Such a stain once left on the touch panel can hardly be removed and may become distinct depending upon e.g. the degree of light, thus leading to a problem such that the visibility or appearance tends to be impaired. Further, the same problem has been pointed out also with respect to a display glass, an optical element, a sanitary appliance, etc.

In order to solve such a problem, a method has been known in which a substrate having an antifouling film of a fluorinated organic silicon compound formed thereon, is employed at the portion of such a component or appliance to be in contact with a human finger. The antifouling film formed on the substrate is desired to have high water repellency and oil repellency to prevent a stain from remaining and is also desired to have abrasion resistance against wiping the stain off.

As an attempt to satisfy both the water/oil repellency and the abrasion resistance of such a substrate having an antifouling film formed thereon, for example, Patent Document 1 discloses a method of treating the surface of the substrate by ion beams containing argon and oxygen to form concaves, then forming a primer layer to maintain the shape thereon, and further, forming an antifouling film of a fluorinated organic silicon compound thereon.

Here, in Patent Document 1, it is shown that for the purpose of forming concaves on the substrate, in all Examples, surface treatment of the substrate was conducted by ion beam irradiation by means of a mixed gas of argon and oxygen, whereby the abrasion resistance was improved. However, the method in Patent Document 1 cannot be said to sufficiently satisfy the abrasion resistance required for practical use, and an antifouling film having the abrasion resistance further improved is desired.

### PRIOR ART DOCUMENT

### Patent Document

Patent Document 1: JP-A-2010-90454

### DISCLOSURE OF INVENTION

### Technical Problem

It is an object of the present invention to provide an antifouling film-coated substrate having a fluorinated organic silicon compound coating film, which is excellent in antifouling properties as it has water repellency and oil repellency and which is excellent also in abrasion resistance whereby deterioration in the antifouling properties by e.g. repeated wiping operations is prevented, and a process for its production.

### Solution to Problem

The antifouling film-coated substrate of the present invention comprises a transparent substrate having a film-forming surface exposed to at least a moisture-containing atmosphere, and a fluorinated organic silicon compound coating film formed on the film-forming surface of this transparent substrate by a dry-mode method.

The process for producing an antifouling film-coated substrate of the present invention is a process for producing an antifouling film-coated substrate comprising a transparent substrate and a fluorinated organic silicon compound coating film formed thereon, which comprises an atmosphere treatment step and a film-forming step at least in this order. The atmosphere treatment step is a step of exposing a film-forming surface of the transparent substrate on which the fluorinated organic silicon compound coating film is to be formed, to at least a moisture-containing atmosphere. The film-forming step is a step of applying and reacting, after the atmosphere treatment step, a composition containing a fluorinated hydrolysable silicon compound on the film-forming surface to form the fluorinated organic silicon compound coating film.

### Advantageous Effects of Invention

According to the present invention, it is possible to provide an antifouling film-coated substrate having a fluorinated organic silicon compound coating film, which is excellent in antifouling properties as it has water repellency and oil repellency and which is excellent also in abrasion resistance whereby deterioration in the antifouling properties against e.g. repeated wiping operations, is prevented, and a process for its production.

### BRIEF DESCRIPTION OF DRAWINGS

FIG. 1 is a cross-sectional view illustrating one embodiment of the antifouling film-coated substrate.

FIG. 2 is a schematic cross-sectional view illustrating an example of a humidifying device to be used for the atmosphere treatment.

FIG. 3 is a schematic cross-sectional view illustrating an example of a plasma treatment device (LIS).

FIG. 4 is a schematic cross-sectional view illustrating an example of a film-forming apparatus.

FIG. 5 is a schematic cross-sectional view illustrating another example of a film-forming apparatus.

FIG. 6 is a schematic cross-sectional view illustrating still another example of a film-forming apparatus.

FIG. 7 is a graph showing the results of an abrasion durability (abrasion resistance) test.

### DESCRIPTION OF EMBODIMENTS

Now, embodiments to carry out the present invention will be described with reference to the drawings. However, it should be understood that the present invention is by no means limited to the following embodiments, and various modifications and substitutions may be made to the following embodiments without departing from the scope of the present invention.

### [Antifouling Film-Coated Substrate]

The antifouling film-coated substrate comprises a transparent substrate having a film-forming surface exposed to at least a moisture-containing atmosphere, and a fluorinated organic silicon compound coating film formed on the film-forming surface of this transparent substrate by a dry-mode method. Hereinafter, the fluorinated organic silicon compound coating film will be referred to simply as the coating film.

The coating film is one to be formed by the following hydrolytic condensation reaction of the following fluorinated hydrolysable silicon compound on the film-forming surface of the transparent substrate, and it functions as an antifouling film as it has water repellency and oil repellency. Here, in this specification, the fluorinated hydrolysable silicon compound is meat for a compound which has a hydrolysable silyl group having a hydrolysable group or atom bonded to a silicon atom and which further has a fluorinated organic group bonded to the silicon atom. Here, in this specification, the hydrolysable group or atom constituting the hydrolysable silyl group, as bonded to the silicon atom, will also be referred to as a “hydrolysable group”.

That is, the coating film is formed in such a manner that hydrolysable silyl groups in the fluorinated hydrolysable silicon compound undergo hydrolysis and become silanol groups, which are then undergo intermolecular dehydration condensation to form siloxane bonds represented by —Si—O—Si—. In the obtained coating film, most of the above-mentioned fluorinated organic groups bonded to silicon atoms in the siloxane bonds, are present in the vicinity of the film-forming surface on the opposite side to the transparent substrate. By the action of such fluorinated organic groups, it becomes possible to present the water repellency and oil repellency. Further, the silanol groups formed as mentioned above, are chemically bonded with hydroxyl groups of the film-forming surface by a dehydration condensation reaction to form adhesion points (substrate-O—Si).

Here, in the antifouling film-coated substrate having a coating film formed on the film-forming surface via the above steps, by increasing the hydroxy group density on the film-forming surface, it is possible to improve the adhesion between the film-forming surface and the coating film and thereby to obtain an antifouling film-coated substrate having high abrasion resistance durable against e.g. repeated wiping operations.

In the present invention, by exposing the film-forming surface of the transparent substrate on which the coating film is to be formed, to at least a moisture-containing atmosphere, the abrasion resistance of the obtainable antifouling film-coated substrate is brought to a high level. The detailed mechanism is not clearly understood, but it is considered that in the present invention, by such treatment, the density of hydroxy groups on the film-forming surface is increased, and the adhesion points between the transparent substrate and the coating film are thereby increased, whereby the abrasion resistance is increased. Here, the increase in the density of hydroxy groups is considered to be attributable to e.g. formation of new hydroxy groups due to the presence of water molecules.

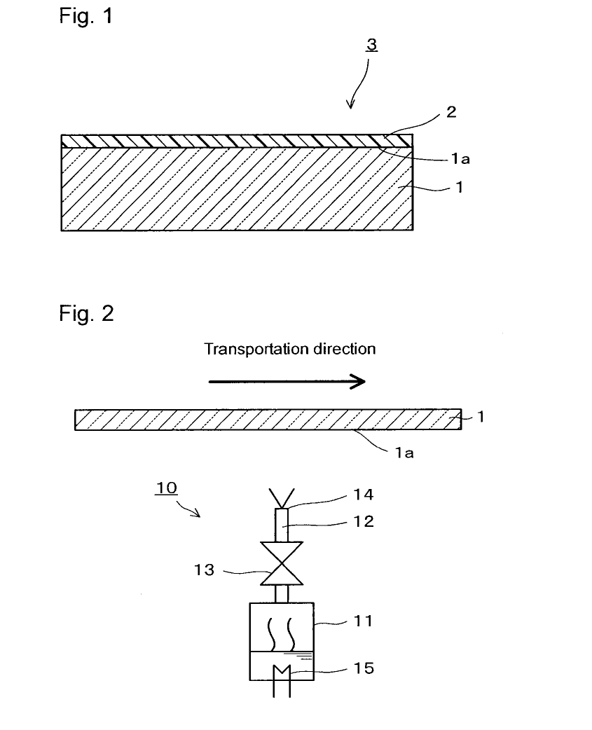

FIG. 1 is a cross-sectional view illustrating one embodiment of the antifouling film-coated substrate of the present invention. The antifouling film-coated substrate 3 comprises a transparent substrate 1 and a coating film 2 formed on a film-forming surface 1a of the transparent substrate 1. Here, the film-forming surface 1a is one exposed to at least a moisture-containing atmosphere. Hereinafter, the treatment of exposing the film-forming surface 1a to at least the moisture-containing atmosphere, will be referred to as the atmosphere treatment.

Now, the respective constituting elements to constitute the antifouling film-coated substrate 3 of the present invention, will be described.

### (Transparent Substrate)

The transparent substrate 1 is one, of which a film-forming surface 1a on which a coating film is to be formed, is exposed to at least a moisture-containing atmosphere. The transparent substrate 1 is not particularly limited so long as it is one made of a transparent material, for which it is usually desired to impart antifouling properties by an antifouling coating film, and one made of glass, a resin or a combination thereof (such as a composite material or a laminated material) is preferably used. The glass may, for example, be usual soda lime glass, borosilicate glass, alkali-free glass or quartz glass, and among them, soda lime glass is particularly preferred. The resin may, for example, be an acrylic resin such as polymethyl methacrylate, an aromatic polycarbonate resin such as a carbonate of bisphenol A, or an aromatic polyester resin such as polyethylene terephthalate (PET), and among them, PET is particularly preferred. Here, as compared with a resin, glass is distinct for improvement in the abrasion resistance by the atmosphere treatment, and therefore, it is particularly preferred to use glass as the transparent substrate 1.

The shape of the transparent substrate 1 may be a flat plate, or the entire surface or a part thereof may have a curvature. The thickness of the transparent substrate 1 may be suitably selected depending upon the application of the antifouling film-coated substrate 3, but it is usually preferably from 0.5 to 10 mm.

The film-forming surface 1a to be exposed to the moisture-containing atmosphere may preliminarily be subjected to acid treatment (treatment using e.g. diluted hydrofluoric acid, sulfuric acid, hydrochloric acid or the like), alkali treatment (treatment using e.g. a sodium hydroxide aqueous solution or the like), or ultrasonic cleaning with ultrapure water or an organic solvent, depending upon the particular purpose.

Further, to the film-forming surface 1a to be exposed to the moisture-containing atmosphere, a vapor deposition film, a sputtered film or an interlayer formed by e.g. a wet-mode method, may preliminarily be provided, as the case requires. The interlayer may be an interlayer composed mainly of silicon oxide formed by using a tetrafunctional hydrolysable silicon compound or perhydropolysilazane, which is provided usually for the purpose of improving the adhesion or durability. Here, in a case where such an interlayer is provided to the film-forming surface 1a to be exposed to the moisture-containing atmosphere, the interlayer is exposed to the moisture-containing atmosphere.

In a case where the transparent substrate 1 is a soda lime glass plate, it is preferred to provide a film for preventing elution of Na ions from the viewpoint of durability. In a case where the transparent substrate 1 is a glass plate produced by a float process, it is preferred to provide a coating film 2 on the top surface having a smaller surface tin amount from the viewpoint of durability.

### (Atmosphere Treatment)

The atmosphere treatment may be one wherein the film-forming surface 1a of the transparent substrate 1 on which the coating film 2 is to be formed, is exposed to at least a moisture-containing atmosphere. Here, the moisture-containing atmosphere shall not include an atmosphere containing moisture which still remains unremoved by sufficient vacuum evacuation. With such an atmosphere, even if the film-forming surface 1a is exposed thereto, it is not possible to obtain high abrasion resistance. As such an atmosphere, one having a water vapor pressure of at most 0.002 Pa may specifically be mentioned. That is, the moisture-containing atmosphere in the present invention is one wherein the water vapor pressure is more than 0.002 Pa.

With a view to obtaining higher abrasion resistance, the water vapor pressure in the moisture-containing atmosphere is preferably at least 0.005 Pa, more preferably at least 0.01 Pa. The water vapor pressure in the moisture-containing atmosphere is preferably at most 0.1 Pa from the viewpoint of the film-forming stability of the composition containing a fluorinated hydrolysable silicon compound on the transparent substrate 1.

The atmosphere treatment may be carried out, for example, by introducing the transparent substrate 1 into a vacuum chamber and bringing the atmosphere in the vacuum chamber to be a moisture-containing atmosphere. Here, the atmosphere treatment may not necessarily be limited to the film-forming surface and may be applied to the entire surface of the transparent substrate 1.

If the film-forming surface 1a is exposed to the moisture-containing atmosphere even for a short time, the adhesion between the film-forming surface 1a and the coating film 2 may be improved, and high abrasion resistance may be obtained. However, with a view to obtaining higher abrasion resistance, the time for exposing the film-forming surface 1a to the moisture-containing atmosphere is preferably at least 5 seconds, more preferably at least 10 seconds. Particularly, it is preferred to adjust the water vapor pressure in the moisture-containing atmosphere to be at least 0.005 Pa and the above time to be at least 20 seconds, more preferably at least 40 seconds. With a view to improving the productivity, the above time is preferably at most 300 seconds, more preferably at most 200 seconds.

Here, in a case where the film-forming surface 1a is exposed to the moisture-containing atmosphere while transporting the transparent substrate 1 in the moisture-containing atmosphere, one obtained by dividing the length of the zone wherein the moisture-containing atmosphere is present, by the transportation speed of the transparent substrate 1, shall be the above time.

FIG. 2 is a schematic cross-sectional view illustrating an example of a humidifying device to be used for the atmosphere treatment. Here in FIG. 2, the transparent substrate 1 to be treated, is also shown. The atmosphere treatment is carried out prior to forming the coating film 2, for example, in a vacuum chamber in which the coating film 2 is to be formed. The moisture-containing atmosphere may be realized, for example, by supplying moisture from a humidifying device 10 provided in such a vacuum chamber.

The humidifying device 10 comprises, for example, a heating container 11 to contain water, preferably pure water, a piping 12 to connect this heating container 11 and a vacuum chamber not shown, a variable valve 13 provided in the middle of the piping 12, to control the vapor amount to be supplied to the vacuum chamber not shown, and a moisture supply section 14 provided at the forward end of the piping 12 in the vacuum chamber. Further, in the heating container 11, for example, a heater 15 is provided to heat and evaporate water, preferably pure water, put therein.

By such a humidifying device 10, water, preferably pure water, in the heating container 11 is evaporated, and via the piping 12, the vapor is supplied to the vacuum chamber. It is thereby possible to make the atmosphere in the vacuum chamber to be a moisture-containing atmosphere. By letting the transparent substrate 1 pass through in such a vacuum chamber by a transportation means not shown, it is possible to expose the film-forming surface 1a to the moisture-containing atmosphere. Here, the atmosphere in the vicinity of the supply section 14 in the vacuum chamber becomes to be an atmosphere having substantially the same water vapor pressure, whereby not only the film-forming surface 1a but also other surface is exposed to the moisture-containing atmosphere, but there will be no problem even if a surface other than the film-forming surface 1a is exposed to the moisture-containing atmosphere.

The humidifying device 10 is adjusted so that the water vapor pressure in the moisture-containing atmosphere in the vacuum chamber is preferably more than 0.002 Pa, more preferably at least 0.005 Pa, particularly preferably at least 0.01 Pa. The water vapor pressure can be adjusted by adjusting the vapor amount to be supplied to the vacuum chamber by the variable valve 13 provided in the middle of the piping 12 connecting the heating container 11 and the vacuum chamber, or by adjusting the vapor amount by adjusting, by means of the heater 15, the temperature of water, preferably pure water, in the heating container 11.

For example, in a case where the water vapor pressure is to be adjusted by adjusting the temperature of water, preferably pure water, by bringing the temperature of water, etc. to be at least 45° C., the water vapor pressure in the moisture-containing atmosphere can be made to be at least 0.005 Pa, and by bringing the temperature of water, etc. to be at least 60° C., the water vapor pressure in the moisture-containing atmosphere can be made to be at least 0.01 Pa. Usually, the temperature of water, etc. is held to be about 45° C., and the vapor amount is adjusted by the variable valve. Further, for example, in a case where the transparent substrate 1 is transported by a transportation means, the time for exposure of the film-forming surface 1a to the moisture-containing atmosphere can be adjusted by adjusting the transportation speed, i.e. the moving speed.

### (Plasma Treatment)

In the atmosphere treatment, it is preferred to use plasma treatment in combination therewith. By the use of plasma treatment in combination therewith, the adhesion between the film-forming surface 1a and the coating film 2 can be further improved to obtain high abrasion resistance. As a method for using the atmosphere treatment and plasma treatment in combination, a method of carrying out the plasma treatment at the same time as the atmosphere treatment, or a method of carrying out the plasma treatment after the atmosphere treatment, may, for example, be mentioned. By either method, it is possible to improve the adhesion between the film-forming surface 1a and the coating film 2 and to obtain high abrasion resistance.

In a case where the plasma treatment is to be carried out at the same time as the atmosphere treatment, for example, in the vacuum chamber, the humidifying device 10 and the after-described plasma treatment device may be disposed close to each other, so that while the atmosphere in the vacuum chamber is made to be a moisture-containing atmosphere by the humidifying device 10, plasma treatment is carried out in this atmosphere. Here, by carrying out the plasma treatment in the moisture-containing atmosphere, the same effect is obtainable irrespective of the disposition order of the humidifying device and the plasma treatment device.

Whereas, in a case where the plasma treatment is to be carried out after the atmosphere treatment, for example, in the vacuum chamber, the humidifying device 10 and the after-described plasma treatment device may be disposed with a certain distance from each other, or the humidifying device and the plasma treatment device may be disposed in separate vacuum chambers, respectively, so that firstly the atmosphere treatment is carried out in the moisture-containing atmosphere and then, the plasma treatment is carried out. Here, the same effect is obtainable even in a reversed order, i.e. even if the atmosphere treatment is carried out after the plasma treatment.

The plasma treatment is particularly preferably treatment by means of oxygen gas plasma, wherein the energy density becomes at least 10 kJ/m². Here, oxygen gas plasma is meant for plasma containing oxygen ions generated by means of a feed gas composed substantially solely of oxygen gas having an oxygen gas concentration of at least 95%. Here, the energy density is an energy density at the plasma-irradiated surface as the film-forming surface 1a. The energy density at the plasma-irradiated surface as the film-forming surface 1a can be calculated by a supplied power and an irradiation time by a plasma generation device to be used. In this specification, the energy density is meant for this energy density unless otherwise specified. The energy density is usually preferably within a range of from 10 to 100 kJ/m² with a view to providing high abrasion resistance and from the viewpoint of the productivity.

The plasma treatment by oxygen gas plasma is carried out, for example, in the same vacuum chamber as the vacuum chamber in which the atmosphere treatment is carried out, by making the atmosphere in the vacuum chamber to be oxygen gas plasma having an energy density of at least 10 kJ/m². Here, the plasma treatment may not necessarily be limited to the film-forming surface 1a, and may be applied to the entire surface of the transparent substrate 1.

The plasma treatment by oxygen gas plasma is preferably a method for contacting oxygen ions only to the film-forming surface 1a of the transparent substrate 1, from the viewpoint of the production efficiency. As such a method, a treatment method may be mentioned in which oxygen ion beams having directionality are applied to the film-forming surface 1a of the transparent substrate 1.

Specifically, a plasma treatment device provided with a linear ion source (hereinafter referred to as “LIS” in this specification) (hereinafter, the plasma treatment device provided with LIS may also be referred to simply as “LIS”) which is capable of treating a large area uniformly and at a high speed, may preferably be used. LIS is an ion source whereby formation of plasma and acceleration of ions can be made by one power source with a simple structure comprising an anode, a cathode and a permanent magnet. The feed gas to be used for the formation of plasma is preferably a feed gas composed substantially solely of oxygen gas. In LIS, the introduced oxygen gas is electrically discharged in a reduced pressure atmosphere to form plasma, and only oxygen ions in the formed plasma are emitted as oxygen ion beams from a slit in the device, by repulsion to the anode.

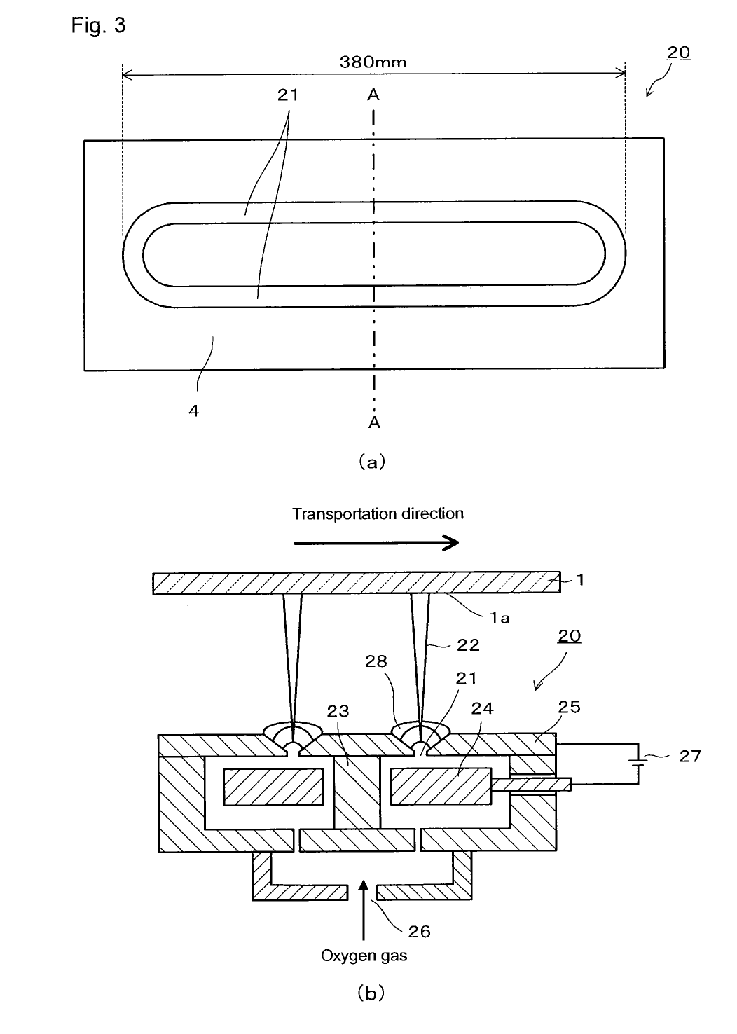

FIG. 3 is a schematic view of a plasma treatment device (LIS). FIG. 3(a) is a front view, and FIG. 3(b) is a view showing a cross-sectional view along line A-A in FIG. 3(a) together with a cross-sectional view of the transparent substrate to be treated. As shown in FIG. 3(a), LIS 20 has two linear slit openings 21 having both ends connected to each other and has such a structure that linear ion beams 22 are emitted from the entire slit openings 21. In the present invention, for example in a case where one main surface of a plate-form transparent substrate 1 is made to be a film-forming surface 1a, uniform irradiation with oxygen ion beams over the entire film-forming surface 1a becomes possible by letting the film-forming surface 1a of the transparent substrate 1 face in substantially parallel with the main surface of LIS 20 and letting either one of LIS 20 and the transparent substrate 1 move in parallel with the other under irradiation with ion beams 22.

As shown in FIG. 3(b), in LIS 20, a magnetic circuit is constructed by disposing a permanent magnet 23 at the center, and disposing an anode 24 and a cathode 25 so that the magnetic field is perpendicular to the electric field at slit openings 21 to emit ion beams 22. LIS 20 has a gas supply port 26 to supply the feed gas, on the opposite side to the side having the slit openings 21.

To LIS 20 made to be a reduced pressure atmosphere, oxygen gas is uniformly supplied from the gas supply port 26 towards the anode 24. To the anode 24, an output power of a discharge power source 27 with an earthed cathode 25 as the reference potential, is connected, and by applying a voltage thereto, formation of plasma and acceleration of oxygen ions are carried out. Here, the magnetic field lines formed at the slit openings 21 are shown by symbol 28 in FIG. 3. The accelerated oxygen ions are emitted as ion beams 22 from the slit openings 21.

Here, at the time of treating the film-forming surface 1a of the transparent substrate 1 by means of LIS 20, as shown in FIG. 3(b), the transparent substrate 1 is set so that the film-forming surface 1a is perpendicular to the oxygen ion beams 22 emitted from LIS 20. The distance from the surface on the side having slit openings 21 of LIS 20 (hereinafter, this surface may be referred to as the front surface) to the film-forming surface 1a of the transparent substrate 1 is set so that the transparent substrate 1 will not to be in contact with LIS 20 in consideration of e.g. deflection of the transparent substrate 1.

Further, as shown in FIG. 3(b), at the time of treating the film-forming surface 1a of the transparent substrate 1 by means of LIS 20, the transparent substrate 1 is transported at a constant speed in the direction of an arrow while irradiated with ion beams 22, whereby oxygen ion beams are applied over the entire film-forming surface 1a. Here, in such a case, as LIS 20, LIS 20 is employed wherein the length of slit openings 21 is at least the length of the side perpendicular to the transportation direction, of the film-forming surface 1a of the transparent substrate 1.

With respect to the energy density in a case where irradiation of the film-forming surface 1a with oxygen ion beams is thus carried out by means of LIS 20 while transporting the transparent substrate 1 at a constant speed, in this specification, an energy density calculated by the following formula will be adopted.

Energy density (kJ/m²)=Electric power applied per LIS unit length (W/m)/(transportation speed (m/sec.)×10³)

The specific supply amount of oxygen gas to be introduced to LIS 20 depends on the type of LIS to be used. In any case where LIS is used, the minimum flow rate where the LIS discharges safely, is preferred. For example, in a case where the transparent substrate 1 is transported at a transportation speed of from 5 to 70 mm/sec., the electric power applied to LIS 20 is preferably from 5 to 3,800 W/m, more preferably from 100 to 2,300 W/m, as an electric power applied per unit length (m) of LIS 20.

### <Fluorinated Organic Silicon Compound Coating Film>

The coating film 2 is preferably formed while the surface state of the film-forming surface 1a after the atmosphere treatment, or after the plasma treatment as the case requires, is maintained. For this purpose, the coating film 2 is formed by a dry-mode method, preferably by a vacuum vapor deposition method. Here, the formation of the coating film 2 is carried out by using a coating film-forming composition, containing a fluorinated hydrolysable silicon compound. Further, the fluorinated organic silicon compound coating film 2 is preferably formed on a transparent substrate 1 continuously in a reduced pressure atmosphere after the plasma treatment, from the viewpoint of the productivity. However, the transparent substrate 1 subjected to the plasma treatment may be once taken out into the atmosphere and then, in a separate device, the fluorinated organic silicon compound coating film 2 may be formed.

The composition for forming the coating film is not particularly limited so long as it is a composition containing the fluorinated hydrolysable silicon compound and a composition capable of forming a coating film by a dry-mode method. The composition for forming the coating film may contain an optional component other than the fluorinated hydrolysable silicon compound. Such an optional compound may, for example, be a hydrolysable silicon compound having no fluorine atom (hereinafter referred to as a “non-fluorinated hydrolysable silicon compound”), a catalyst or the like which may be used within a range not to impair the effects of the present invention.

Further, at the time of incorporating the fluorinated hydrolysable silicon compound and an optional non-fluorinated hydrolysable silicon compound to the composition for forming the coating film, each compound may be incorporated as it is, or as its partially hydrolyzed condensate. Otherwise, each compound may be incorporated as a mixture of the compound and its partially hydrolyzed condensate to the composition for forming the coating film.

Further, in a case where two or more hydrolysable silicon compounds are to be used in combination, each compound may be incorporated as it is, or as its partially hydrolyzed condensate, to the composition for forming the coating film, or they may be incorporated as a partially hydrolyzed co-condensate of two or more compounds. Otherwise, they may be a mixture of such compounds, partially hydrolyzed condensates and partially hydrolyzed co-condensates. However, a partially hydrolyzed condensate or a partially hydrolyzed co-condensate to be used, shall be one having a polymerization degree such that film formation by a dry-mode method is thereby possible. Hereinafter, the term “hydrolysable silicon compound” will be used to include, in addition to the compound itself, such a partially hydrolyzed condensate and a partially hydrolyzed co-condensate.

### (Fluorinated Hydrolysable Silicon Compound)

The fluorinated hydrolysable silicon compound to be used in the present invention, is not particularly limited so long as the coating film 2 thereby obtainable has antifouling properties such as water repellency, oil repellency, etc.

Specifically, a fluorinated hydrolysable silicon compound having at least one group selected from the group consisting of a perfluoropolyether group, a perfluoroalkylene group and a perfluoroalkyl group, may be mentioned. Such a group is present as a fluorinated organic group bonded directly, or via a connecting group, to the hydrolysable silyl group. Here, the perfluoropolyether group is meant for a bivalent group having a structure wherein a perfluoroalkylene group and an etheric oxygen atom are alternately bonded. Further, the number average molecular weight (Mn) of the fluorinated hydrolysable silicon compound in the present invention is preferably from 2,000 to 10,000, more preferably from 3,000 to 5,000. When the number average molecular weight (Mn) is within such a range, it is possible to obtain a film having sufficient antifouling properties and being excellent also in abrasion resistance. Here, the number average molecular weight (Mn) in this specification is one measured by gel permeation chromatography.

As described above, in the coating film obtainable by a reaction of the fluorinated hydrolysable silicon compound at the film-forming surface of the transparent substrate 1, the above-mentioned fluorinated organic groups are present in the vicinity of the film-forming surface of the coating film, whereby it becomes a coating film having antifouling properties such as water repellency, oil repellency, etc. Specific examples of the fluorinated hydrolysable silicon compound having such groups may, for example, be compounds represented by the following formulae (I) to (V). In this specification, a compound represented by the formula (I) may be referred to also as a compound (I). The same applies to compounds represented by other formulae.

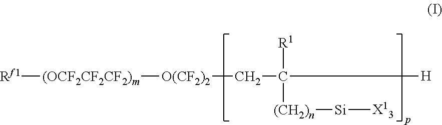

In the formula (I), R^{f1} is a C₁₋₁₆ linear perfluoroalkyl group (the alkyl group may, for example, be a methyl group, an ethyl group, a n-propyl group, an isopropyl group or a n-butyl group), R¹ is a hydrogen atom or a C₁₋₅ lower alkyl group (e.g. a methyl group, an ethyl group, a n-propyl group, an isopropyl group or a n-butyl group), X¹ is a hydrolysable group (e.g. an amino group, an alkoxy group, an acyloxy group, an alkenyloxy group or an isocyanate group) or a halogen atom (e.g. a fluorine atom, a chlorine atom, a bromine atom or an iodine atom), m is an integer of from 1 to 50, preferably from 1 to 30, n is an integer of from 0 to 2, preferably 1 or 2, and p is an integer of from 1 to 10, preferably from 1 to 8.

In the compound (I), the number of carbon atoms in R^{f1} is preferably from 1 to 4. Further, R¹ is preferably a methyl group. The hydrolysable group represented by X¹ is preferably a C₁₋₆ alkoxy group, more preferably a methoxy group or an ethoxy group.

C_{q}F_{2q+1}CH₂CH₂Si(NH₂)₃ (II)

In the formula (II), q is an integer of at least 1, preferably from 2 to 20.

As the compound represented by the formula (II), for example, n-trifluoro(1,1,2,2-tetrahydro)propylsilazane (n-CF₃CH₂CH₂Si(NH₂)₃) or n-heptafluoro(1,1,2,2-tetrahydro)pentylsilazane (n-C₃F₇CH₂CH₂Si(NH₂)₃) may be exemplified.

CᵣF₂ᵣ₊₁CH₂CH₂Si(OCH₃)₃ (III)

In the formula (III), r is an integer of at least 1, preferably from 1 to 20.

As the compound represented by the formula (III), 2-(perfluorooctyl)ethyltrimethoxysilane (n-C₈F₁₇CH₂CH₂Si(OCH₃)₃) may, for example, be exemplified.

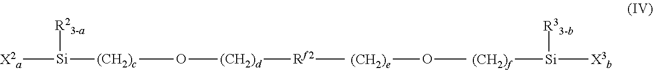

In the formula (IV), R^{f2} is a bivalent linear perfluoropolyether group represented by —(OC₃F₆)ₛ—(OC₂F₄)ₜ—(OCF₂)ᵤ— (wherein each of s, t and u which are independent of one another, is an integer of from 0 to 200), each of R² and R³ which are independent of each other, is a C₁₋₈ monovalent hydrocarbon group (e.g. a methyl group, an ethyl group, a n-propyl group, an isopropyl group or a n-butyl group), each of X² and X³ which are independent of each other, is a hydrolysable group (e.g. an amino group, an alkoxy group, an acyloxy group, an alkenyloxy group or an isocyanate group) or a halogen atom (e.g. a fluorine atom, a chlorine atom, a bromine atom or an iodine atom), each of d and e which are independent of each other, is an integer of 1 or 2, each of c and f which are independent of each other is an integer of from 1 to 5 (preferably 1 or 2), and each of a and b which are independent of each other, is 2 or 3.

In R^{f2} of the compound (IV), s+t+u is preferably from 20 to 300, more preferably from 25 to 100. Further, each of R² and R³ is preferably a methyl group, an ethyl group or a butyl group. The hydrolysable group represented by X² or X³ is preferably a C₁₋₆ alkoxy group, more preferably a methoxy group or an ethoxy group. Further, each of a and b is preferably 3.

F—(CF₂)ᵥ—(OC₃F₆)_{w}—(OC₂F₄)_{y}—(OCF₂)_{z}(CH₂)ₕO(CH₂)ᵢSi(X⁴)₃₋ₖ(R⁴)ₖ (V)

In the formula (V), v is an integer of from 1 to 3, each of w, y and z which are independent of one another, is an integer of from 0 to 200, h is 1 or 2, i is an integer of 2 to 20, X⁴ is a hydrolysable group, R⁴ is a C₁₋₂₂ linear or branched hydrocarbon group, and k is an integer of from 0 to 2. w+y+z is preferably from 20 to 300, more preferably from 25 to 100. Further, i is preferably from 2 to 10. X⁴ is preferably a C₁₋₆ alkoxy group, more preferably a methoxy group or an ethoxy group. R⁴ is preferably a C₁₋₁₀ alkyl group.

Further, as a commercially available fluorinated organic silicon compound having at least one group selected from the group consisting of a perfluoropolyether group, a perfluoroalkylene group and a perfluoroalkyl group, KP-801 (tradename, manufactured by Shin-Etsu Chemical Co., Ltd.), X-71 (tradename, manufactured by Shin-Etsu Chemical Co., Ltd.), KY-178 (tradename, manufactured by Shin-Etsu Chemical Co., Ltd.), or Optool (tradename (registered trademark)) DSX (manufactured by Daikin Industries, Ltd.) may, for example, be preferably used.

Here, if a fluorinated hydrolysable silicon compound as a commercial product is supplied together with a solvent, it should be used by removing the solvent. The coating film-forming composition to be used in the present invention is prepared by mixing the above-described fluorinated hydrolysable silicon compound with optional components to be added as the case requires, and then supplied for the film formation.

Such a coating film-forming composition containing the fluorinated hydrolysable silicon compound is applied and reacted for film formation on the film-forming surface 1a of the transparent substrate 1, to obtain a coating film 2. Here, with respect to the specific application method and reaction conditions, a conventional known method, conditions, etc. may be suitably used.

For example, it may be produced by the following process for producing an antifouling film-coated substrate 3 having a coating film 2.

The thickness of the coating film 2 is preferably at most 50 nm from the viewpoint of the appearance and costs, and its lower limit is the thickness of a monomolecular layer. The thickness of the coating film is more preferably from 2 to 30 nm, particularly preferably from 5 to 20 nm.

### [Process for Producing Antifouling Film-Coated Substrate]

The process for producing an antifouling film-coated substrate 3 is a process for producing an antifouling film-coated substrate 3 comprising a transparent substrate 1 and a coating film 2 formed thereon, and comprises an atmosphere treatment step and a film-forming step in this order. The atmosphere treatment step includes a step of exposing a film-forming surface 1a of the transparent substrate 2 on which the coating film 2 is to be formed, to at least a moisture-containing atmosphere. The film-forming step includes, after the atmosphere treatment step, a step of applying and reacting a composition containing a fluorinated hydrolysable silicon compound on the film-forming surface 1a to form the coating film 2.

By such a process, the coating film 2 is formed on the transparent substrate 1 with high adhesion, whereby with the obtainable antifouling film-coated substrate 3, it is possible to satisfy both antifouling properties such as excellent water repellency and oil repellency and abrasion resistance at a high level.

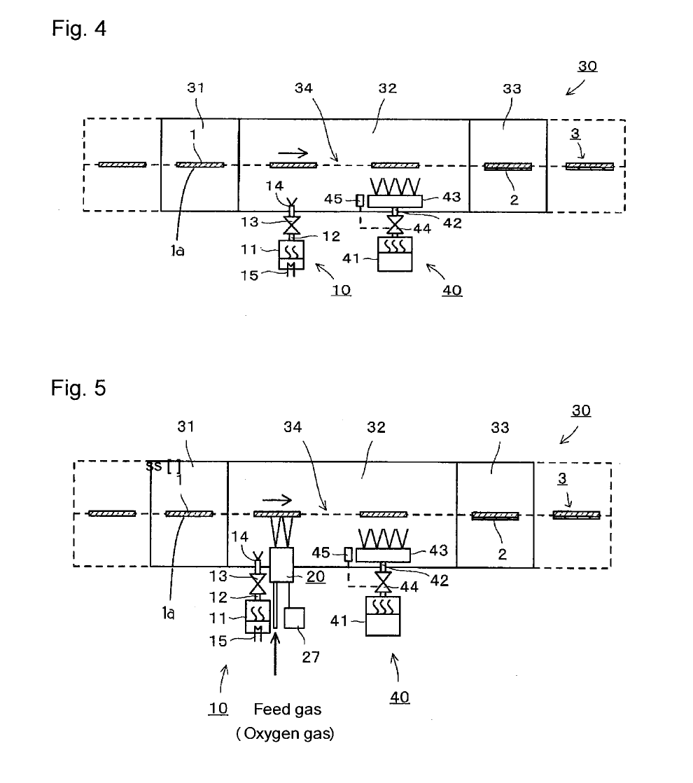

FIG. 4 is a cross-sectional view schematically illustrating a film-forming apparatus useful in one embodiment of the process for producing an antifouling film-coated substrate 3. Now, with reference to FIG. 4, the respective steps will be described. In a case where a film-forming apparatus 30 as shown in FIG. 4 is employed, a transparent substrate 1 is transported from left to right in the Fig. by a transportation means 34, so that it passes through a pre-chamber 31, a vacuum chamber 32 and a substrate take-out chamber 33, and in the vacuum chamber 32, it is subjected to the atmosphere treatment step and the film-forming step in this order and thereby formed into an antifouling film-coated substrate 3.

### (Atmosphere Treatment Step)

The atmosphere treatment step is a step of exposing a film-forming surface 1a of the transparent substrate 1 on which a coating film 2 is to be formed, to at least a moisture-containing atmosphere and is usually carried out in a vacuum chamber 32 as shown in FIG. 4.

The transparent substrate 1 is transported to a pre-chamber 31 which is connected to a vacuum chamber 32 and constructed to be independently capable of aeration/evacuation, before it is introduced into the vacuum chamber 32. After the transportation of the transparent substrate 1, the pre-chamber 31 is closed and evacuated to be in a vacuum state, whereupon a door (not shown) between the pre-chamber 31 and the vacuum chamber 32 is opened, and the transparent substrate 1 is transported to the vacuum chamber 32. In the vacuum chamber 32, on the pre-chamber 31 side, a humidifying device 10 for the atmosphere treatment step is provided and then, a vapor-deposition device 40 for the film-forming step is provided.

In order to take out the transparent substrate 1 after the vapor deposition from the vacuum chamber 32 while the vacuum state is maintained, the side of the vacuum chamber 32 opposite to the side connected to the pre-chamber 31 is connected to a substrate take-out chamber 33 constructed to be independently capable of aeration/evacuation. At the time of transporting the transparent substrate 1 after the vapor deposition from the vacuum chamber 32 to the substrate take-out chamber 33, the substrate take-out chamber 33 is evacuated to be in a vacuum state. Then, at the time of taking out the transparent substrate after the vapor deposition from the substrate take-out chamber 33, a door (not shown) between the substrate take-out chamber 33 and the vacuum chamber 32 is closed, whereby the vacuum state in the vacuum chamber 32 is maintained.

The pressure in the vacuum chamber 32 is maintained to be preferably at most 1 Pa, more preferably at most 0.1 Pa, from the viewpoint of the production stability.

The method of exposing the film-forming surface 1a of the substrate 1 on which the coating film 2 is to be formed, to the moisture-containing atmosphere by means of the humidifying device 10, is as described above. The supply section 14 of the humidifying device 10 is disposed, for example, inside of the vacuum chamber 32, and the distance between the supply section 14 and the film-forming surface 1a of the transparent substrate 1 is not particularly limited so long as it is possible to effectively expose the film-forming surface 1a of the transparent substrate 1 to the moisture-containing atmosphere, but is preferably from 10 to 200 mm, more preferably from 50 to 100 mm. Further, the transportation speed of the transparent substrate 1 is also not necessarily limited so long as the film-forming surface 1a can be exposed to at least the moisture-containing atmosphere, and the transportation speed should better be high from the viewpoint of the productivity, but is limited by the time required to evacuate the pre-chamber 31 to be in a vacuum state.

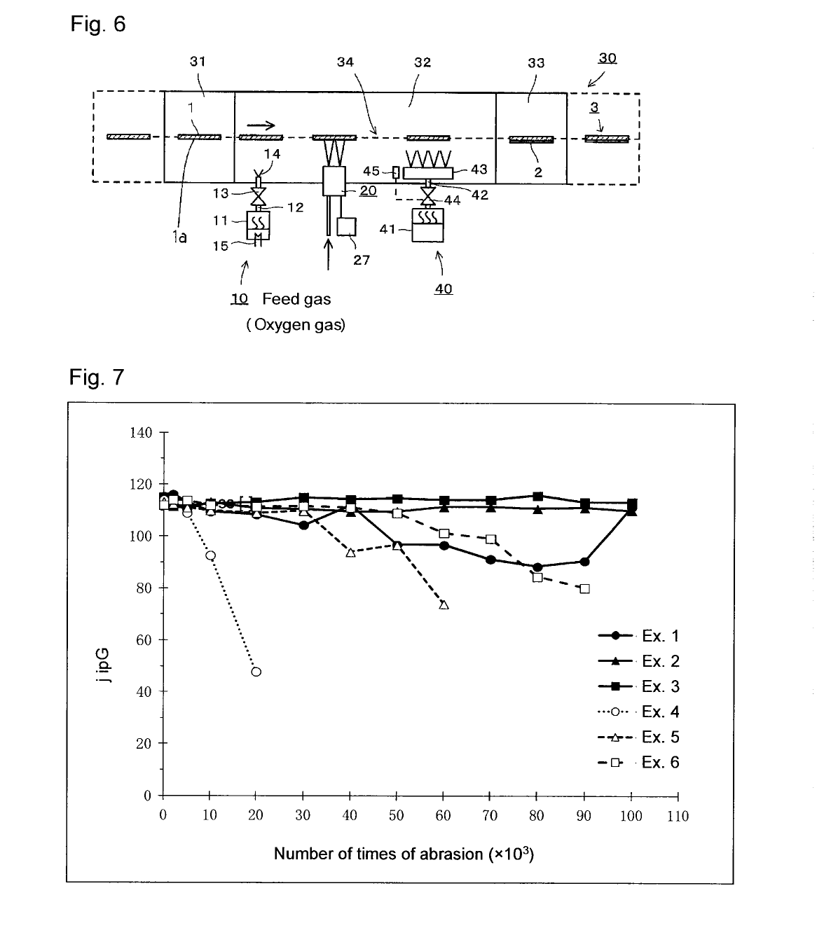

In a case where in the atmosphere treatment step, plasma treatment is carried out at the same time as atmospheric treatment, for example, a film-forming apparatus 30 as shown in FIG. 5 is employed. That is, from the pre-chamber 31 side, a humidifying device 10, a plasma treatment device 20, preferably LIS 30, and a vapor deposition device 40, are provided in this order, and particularly, the humidifying device 10 and the plasma treatment device 20 are disposed close to each other. Here, in the case of carrying out the plasma treatment at the same time, the plasma treatment device may be disposed in the treatment atmosphere, and the disposition order of the humidifying device 10 and the plasma treatment device 20 may be reversed.

Whereas, in a case where the atmosphere treatment step and the plasma treatment step are carried out separately, for example, a film-forming apparatus 30 as shown in FIG. 6 is employed. That is, from the pre-chamber 31 side, a humidifying device 10, a plasma treatment device 20, preferably LIS 30, and a vapor deposition device 40, are provided in this order. In the case of carrying out the treatments separately, the humidifying device 10 and the plasma treatment device 20 are disposed preferably at a distance of at least 200 mm without being disposed close to each other. Further, it is preferred to install a vacuum pump between the humidifying device 10 and the plasma treatment device 20 to separate the atmosphere, and it is more preferred to carry out the atmosphere treatment and the plasma treatment in separate vacuum chambers. In such a case, it is preferred to firstly carry out the atmosphere treatment in the moisture-containing atmosphere and then carry out the plasma treatment. However, the same results may be obtained by carrying out the atmosphere treatment after the plasma treatment in the reversed order.

The distance between the front surface of the plasma treatment device 20, particularly LIS 20, and the film-forming surface 1a of the transparent substrate 1, is preferably from 30 to 200 mm, more preferably from 50 to 10 mm, with a view to avoiding a contact between the transparent substrate 1 and LIS 20 and reducing the size of the apparatus. Further, the transportation speed of the transparent substrate is also not particularly limited so long as it is so set that the energy density would be within the above-mentioned range, and the transportation speed should better be high from the viewpoint of the productivity, but is limited by the time required to evacuate the pre-chamber 31 to be in a vacuum state.

As LIS to be used for oxygen ion beam irradiation, it is possible to use, for example, LIS-38FM (tradename: manufactured by Advanced Energy Industries, Inc.) or PPALS81 (tradename: manufactured by General Plas, a Inc.).

### (Film-Forming Step)

A composition containing a fluorinated hydrolysable silicon compound is applied and reacted on the film-forming surface 1a of the transparent substrate 1, which has been subjected to the atmosphere treatment step and, if required, the plasma treatment at the same time, or which has been subjected to the atmosphere treatment, followed by the plasma treatment if required, or which has been subjected to the plasma treatment step if required, followed by the atmospheric treatment. The composition containing a fluorinated hydrolysable silicon compound will be referred to as the coating film-forming composition, as mentioned above.

The method for applying the coating film-forming composition on the film-forming surface 1a is not particularly limited so long as it is a method commonly used to apply a fluorinated hydrolysable silicon compound, and for example, a dry-mode method such as a vacuum vapor deposition method, a CVD method or a sputtering method, may be mentioned. A vacuum vapor deposition method is preferred with a view to preventing decomposition of the fluorinated hydrolysable silicon compound to be used, and from the viewpoint of the simplicity of the apparatus.

A vacuum vapor deposition method is particularly preferred in a case where the coating film-forming composition is applied to the film-forming surface 1a immediately after the atmosphere treatment step, or the plasma treatment step conducted after the atmosphere treatment as the case requires, in the same vacuum chamber 32 by means of the film-forming apparatus 30 as shown in FIGS. 4 to 6.

Vacuum vapor deposition methods may be classified into a resistance heating method, an electron beam heating method, a high frequency induction heating method, a reactive vapor deposition method, a molecular beam epitaxy method, a hot wall vapor deposition method, an ion plating method, a cluster ion beam method, etc., and any method may be used. A resistance heating method may suitably be employed with a view to preventing decomposition of the fluorinated hydrolysable silicon compound to be used and in view of the simplicity of the apparatus. The vapor deposition device is not particularly limited, and a conventional device may be employed. Now, a method for vapor depositing the coating film-forming composition on the treated surface of the plasma-treated transparent substrate, by means of a vacuum vapor deposition device 40 by a vacuum vapor deposition method, particularly by a resistance heating method, in the vacuum chamber 32 as shown in FIGS. 4 to 6, will be described.

As mentioned above, the pressure in the vacuum chamber 32 is maintained to be preferably at most 1 Pa, more preferably at most 0.2 Pa. Under such a pressure, the vacuum vapor deposition by a resistance heating method can be carried out without any problem.

The vacuum vapor deposition device 40 is provided on the substrate take-out chamber 33 side of the plasma treatment device 20 in the vacuum chamber 32. Here, the position of the transparent substrate 1 to be treated by the humidifying device 10, or in a case where the plasma treatment is carried out as the case requires, the position of the transparent substrate 1 to be treated by the plasma treatment device 20, and the position of the transparent substrate 1 to be treated by the vacuum vapor deposition device 40 for vapor deposition of the fluorinated hydrolysable silicon compound, are preferably apart from each other at such a distance that the respective treatments would not be influenced by the other, specifically at a distance of at least 200 mm. Further, it is preferred to install a vacuum pump between the treatment device and the vapor deposition device to separate the atmosphere, and it is more preferred to carry out the treatment and the vapor deposition in separate vacuum chambers.

The vacuum vapor deposition device 40 comprises a heating container 41 to heat the coating film-forming composition outside the vacuum chamber 32, and inside the vacuum chamber 32, a piping 42 to supply the vapor from the heating container 41 and a manifold 43 connected to the piping 42 and having jet orifices to spray the vapor supplied from the heating container 41 to the film-forming surface 1a of the transparent substrate 1. Here, in the vacuum chamber 32, the transparent substrate 1 is held so that the film-forming surface 1a of the transparent substrate 1 faces the jet orifices of the manifold 43.

The heating container 41 has a heating means to heat the coating film-forming composition as the vapor deposition source to a temperature at which the composition has a sufficient vapor pressure. The heating temperature may depends also on the type of the coating film-forming composition, but specifically, it is preferably from 30° C. to 400° C., particularly preferably from 50° C. to 300° C. When the heating temperature is at least the lower limit value in the above range, the film-forming rate will be good. When it is at most the upper limit value in the above range, it is possible to form a coating film having antifouling properties on the film-forming surface 1a without decomposition of the fluorinated hydrolysable silicon compound.

Here, at the time of the vacuum vapor deposition, it is preferred to carry out preliminary treatment of discharging the vapor out of the system for a predetermined time after heating the coating film-forming composition containing the fluorinated hydrolysable silicon compound in the heating container 41 to the vapor deposition initiation temperature. By this preliminary treatment, it is possible to remove low molecular weight components, etc. which are influential to the durability of the obtainable coating film and which are usually contained in the fluorinated hydrolysable silicon compound, and it becomes possible to stabilize the composition of the raw material vapor supplied from the vapor deposition source. Thus, it becomes possible to form a coating film 2 having high durability constantly.

Specifically, a method may be adopted wherein at an upper portion of the heating container 41, a piping (not shown) connected to a freely openable/closable exhaust port to discharge the initial vapor out of the system is provided separate from the piping 42 connected to the manifold 43, so that the initial vapor is trapped outside of the system.

Further, the temperature of the transparent substrate 1 during the vacuum vapor deposition is preferably within a range of from room temperature (20 to 25° C.) to 200° C. When the temperature of the transparent substrate 1 is at most 200° C., the film-forming rate will be good. The upper limit value of the temperature of the transparent substrate 1 is more preferably 150° C., particularly preferably 100° C.

Further, the manifold 43 is preferably provided with a heater for heating to prevent the vapor supplied from the heating container 41 from condensing. The piping 42 is preferably designed so that it will be heated together with the heating container 41 in order to prevent the vapor from the heating container 41 from condensing on the way.

Further, in order to control the film-forming rate, it is preferred to provide a variable valve 44 on the piping 42 and to control the degree of opening of the variable valve 44 based on the value detected by a film thickness meter 45 provided in the vacuum chamber 32. By providing such a construction, it becomes possible to control the amount of the vapor of the composition containing the fluorinated hydrolysable silicon compound, which is supplied to the film-forming surface 1a of the transparent substrate 1. Thus, it is thereby possible to form a coating film 2 having a desired thickness with good accuracy on the film-forming surface 1a of the transparent substrate 1. Further, as the film thickness meter 45, a quartz oscillator monitor may, for example, be employed. Further, for example, in a case where as the film thickness meter 45, an X-ray diffraction meter for thin-film analysis ATX-G (manufactured by RIGAKU CORPORATION) is used for the measurement of a film thickness, an interference pattern of reflective X-rays is obtained by an X-ray reflectivity technique, and the film thickness can be calculated from the oscillation period of the interference pattern. Thus, the coating film-forming composition containing the fluorinated hydrolysable silicon compound is vapor-deposited on the film-forming surface 1a. At the same time as the vapor deposition or after the vapor deposition, the fluorinated hydrolysable silicon compound undergoes a hydrolytic condensation reaction, whereby it is chemically bonded to the film-forming surface 1a having a density of hydroxy groups increased by the above treatment, and it undergoes intermolecular siloxane bonding to form a coating film 2.

This hydrolytic condensation reaction of the fluorinated hydrolysable silicon compound proceeds at the film-forming surface 1a at the same time as the vapor deposition. In order to further sufficiently accelerate this reaction, as the case requires, after taking out the transparent substrate 1 having the coating film 2 formed thereon from the vacuum chamber, heat treatment may be carried out by using a hot plate or a constant temperature and humidity tank. As the conditions for the heat treatment, for example, heat treatment at a temperature of from 80 to 200° C. for from 10 to 60 minutes may be mentioned.

The antifouling film-coated substrate 3 obtainable by the above process is excellent in antifouling properties such as water repellency and oil repellency and at the same time has high abrasion resistance durable against e.g. repeated wiping operations. This is considered to be attributable to such results that by the atmosphere treatment, the density of hydroxy groups at the film-forming surface 1a has increased, and to such hydroxy groups, hydrolysable silyl groups of the fluorinated hydrolysable silicon compound have reacted whereby the adhesion points between the obtained substrate 1 and the coating film 2 are increased.

### EXAMPLES

Now, the present invention will be described with reference to specific Examples, but it should be understood that the present invention is by no means limited to these Examples. Ex. 1 to 3 are Examples of the present invention, and Ex. 4 to 6 are Comparative Examples.

In these Examples, by means of the film-forming apparatus 30 as shown in FIG. 5, i.e. one whereby the atmosphere treatment, the plasma treatment as the case requires, and further, the vacuum vapor deposition treatment can be carried out continuously in the vacuum chamber 32, and the atmosphere treatment and the plasma treatment can be carried out simultaneously, a coating film 2 was formed on a transparent substrate 1 by the following procedure, and thus, an antifouling film-coated substrate 3 was obtained in each of Ex. 1 to 6. With respect to the antifouling film-coated substrate 3, an abrasion resistance test of water repellency was carried out for its evaluation.

### (Apparatus, Materials Constituting Antifouling Film-Coated Substrate, and Raw Materials)

As the film-forming apparatus 30, a vertical in-line film-forming apparatus (apparatus name: SDP-85VT, manufactured by ULVAC, Inc.) comprising a pre-chamber 31, a vacuum chamber 32, a substrate take-out chamber 33 and a transportation means 34 to transport a transparent substrate 1, was used. In the vacuum chamber 32 of the film-forming apparatus 30, from the pre-chamber 31 side, a humidifying device 10, a plasma treatment device 20 (LIS 20) and a vacuum vapor deposition device 40 were installed.

The humidifying device 10 was one comprising a heating container 11 made of stainless steel, a piping 12 connecting this heating container 11 and the vacuum chamber 32, a supply section 14 provided at the forward end of this piping 12 and located in the vacuum chamber 32, and a heater 15 disposed in the heating container 11. The size of the heating container 11 was 70 mm in diameter×120 mm. The opening of the supply section 14 had such a shape that holes of 1 mm in diameter were formed at a pitch of 30 mm in a pipe having a length of 800 mm. The closest distance between the supply section 14 and the transparent substrate 1 was 70 mm. In the heating container 11, pure water was put. Here, at the time of carrying out the atmosphere treatment, pure water in the heating container 11 was heated to 45° C.

As the plasma treatment device 20, a linear ion source (apparatus name: LIS-38FM, manufactured by Advanced Energy Industries, Inc.) was used wherein the length of the ion beam emission slit opening 21 (the length of the ion source) was 380 mm. To the plasma treatment device 20, a DC power source 27 (apparatus name: Pinnacl, manufactured by Advanced Energy Industries, Inc., 6×6 kW) was connected. As the vacuum vapor deposition device 40, a vertical vapor deposition source (manufactured by Hitachi Zosen Corporation) was used.

As the transparent substrate 1, a square aluminosilicate glass substrate of 100 mm on a side (tradename: Dragontrail, manufactured by Asahi Glass Company Limited) with a thickness of 1.1 mm was used. The transparent substrate 1 was subjected to cleaning with an alkali cleaning agent (tradename: Sunwash TL, Lion Corporation) 2% solution, followed by ultrasonic cleaning with ultrapure water, before it was introduced into the film-forming apparatus 30.

As the coating film-forming composition, one having the solvent removed from Optool (tradename (registered trademark)) DSX (manufactured by Daikin Industries, Ltd.) agent (a 20 mass % solution of a fluorinated organic group-containing hydrolysable silicon compound in perfluorohexane) was used.

### (Production of Antifouling Film-Coated Substrate)

### Ex. 1

After placing a transparent substrate 1 in the pre-chamber 31 of the film-forming apparatus 30, the atmosphere treatment step was carried out by transporting the transparent substrate 1 in the vacuum chamber 32 having the pressure adjusted to 0.06 Pa at a transportation speed of 900 mm/min. (=15 mm/sec.). Here, the transportation distance in the vacuum chamber 32, i.e. the distance for the atmosphere treatment step, was set to be 1,800 mm. Thereafter, in the same vacuum chamber 32, the film-forming step of forming a coating film 2 with a thickness of 10 nm was carried out by vacuum vapor deposition of the coating film-forming composition (the fluorinated hydrolysable silicon compound) by means of the vacuum vapor deposition device 40.

Here, in the atmosphere treatment step, pure water in the heating container 11 was heated to 45° C., and the vapor was supplied into the vacuum chamber 32 via the piping 12 and the supply section 14. At that time, the water vapor pressure in the atmosphere in the vacuum chamber 32 was measured by means of a residual gas analyzer (tradename: “Qulee CGM-052”, manufactured by ULVAC, Inc.), whereby the water vapor pressure was 0.005 Pa. Here, in Ex. 1, the plasma treatment device 20 was not operated, i.e. the atmosphere treatment was carried out without simultaneously carrying out the plasma treatment.

In the film-forming step after the atmosphere treatment step, a coating film 2 with a thickness of 10 nm was formed on the film-forming surface 1a of the transparent substrate 1 by vacuum vapor deposition of the coating film-forming composition (the fluorinated hydrolysable silicon compound) by means of the vacuum vapor deposition device 40. Thus, a vapor deposition film-coated substrate 1 was obtained. Specifically, the control of the film thickness was conducted by carrying out vapor deposition while measuring the film thickness by a quartz oscillator monitor and adjusting the film-forming rate. Further, the final film thickness was measured by a spectroscopic ellipsometer (UVISEL, manufactured by Horiba, Ltd.) after the film formation.

Specifically, the film-forming step was carried out as follows. Optool DSX agent as the vapor deposition material was introduced into the heating container 41. Thereafter, the interior of the heating container 41 was evacuated for at least 10 hours by means of a vacuum pump to remove a solvent in the solution to obtain a coating film-forming composition. Then, the heating container 41 containing the coating film-forming composition was heated to 270° C. After reaching 270° C., the same state was maintained for 30 minutes until the temperature was stabilized. Thereafter, the transparent substrate 1 was moved to a predetermined position, and the film-forming step was carried out while measuring the film thickness by the above quartz oscillator monitor to bring the film thickness to 10 nm. When the film thickness reached 10 nm, the film-forming step was terminated, and from the vacuum chamber 32, the vapor deposition film-coated substrate 1 was taken out via the substrate take-out chamber 33. The taken-out substrate 1 was placed on a hot plate so that the film surface faced upward, and heat treatment was carried out in the atmosphere at 150° C. for 60 minutes to obtain an antifouling film-coated substrate 3.

### Ex. 2 and 3

An antifouling film-coated substrate 3 was produced in the same manner as in Ex. 1 except that in the atmosphere treatment step, plasma treatment was carried out at the same time as the atmosphere treatment. The plasma treatment was carried out by operating the plasma treatment device 20 installed side by side with the humidifying device 10. The feed gas was oxygen gas only, and the feed gas amount was adjusted to be the minimum flow amount required for stable electrical discharge. Under a pressure of 0.12 Pa, positive ion beams 22 of plasma formed by supplying a prescribed electric power, were applied. Here, the water vapor pressure at that time was as shown in Table 1, respectively. Further, the energy density was, respectively, adjusted to be 18 kJ/m² (applied electric power: 270 W/m) or 90 kJ/m² (applied electric power: 1350 W/m), as shown in Table 1. Here, the plasma treatment was carried out by adjusting the distance between the front surface of the plasma treatment device 20 and the film-forming surface 1a of the transparent substrate 1 to be 50 mm.

### Ex. 4

An antifouling film-coated substrate 3 was produced by carrying out only the film-forming step in the same manner as in Ex. 1 without carrying out the atmosphere treatment step. That is, the antifouling film-coated substrate 3 was produced by operating only the vacuum vapor deposition device 40 without operating the humidifying device 10 and the plasma treatment device 20.

### Ex. 5 and 6

An antifouling film-coated substrate 3 was produced by carrying out the film-forming step after carrying out only the plasma treatment in the same manner as in Ex. 2 and 3 without carrying out the atmosphere treatment step. That is, the antifouling film-coated substrate 3 was produced by operating the plasma treatment device 20 and the vacuum vapor deposition device 40 without operating the humidifying device 10.

With respect to the antifouling film-coated substrates 3 in Ex. 1 to 6, the abrasion durability (the abrasion resistance) was evaluated by the following method. The results are shown in Table 1 and FIG. 7.

### (Abrasion Durability (Abrasion Resistance) Test)

Firstly, the water contact angle on the antifouling film surface of the antifouling film-coated substrate 3 obtained as described above, was measured. Then, an abrasion test was conducted by the following method, and every time when a prescribed number of abrasion operations had been completed, the water contact angle on the antifouling film surface was measured. The measurement of the water contact angle on the antifouling film surface was conducted by dropping 1 μL of pure water by means of an automatic contact angle meter DM-501 (manufactured by Kyowa Interface Science Co., Ltd.). The water contact angles were measured at five spots on the antifouling film surface, and the average was calculated and used for evaluation.

The specific abrasion test method was carried out by the following procedure. That is, firstly a plain-woven cotton fabric (Kanakin No. 3) was attached to the surface of a flat metal indenter having a bottom surface of 10 mm×10 mm to prepare an abrader for abrading a sample.

Then, using the above abrader, an abrasion test was carried out by means of a plane abrasion tester (3 Arm-type) (manufactured by DAIEI KAGAKU SEIKI MFG. Co., Ltd.). Specifically, firstly the above abrader was attached to the abrasion tester so that the bottom surface of the indenter was in contact with the antifouling film surface of the sample, and a weight was mounted so that a weight of 1,000 g was exerted to the abrader, whereupon the abrader was reciprocated for a distance of 40 mm each way at an average speed of 6,400 mm/min. The test was carried out by taking one reciprocation as two abrasion operations.

TABLE 1

| Ex. | | | 1 | 2 | 3 | 4 | 5 | 6 |
|---|---|---|---|---|---|---|---|---|
| Production | Atmosphere | Yes or no | Yes | Yes | Yes | No | No | No |
| conditions | treatment | Water vapor | 0.05 | 0.05 | 0.06 | 0.002 | 0.0017 | 0.0018 |
| | | pressure (Pa) | | | | | | |
| | Plasma | Yes or no | No | Yes | Yes | No | Yes | Yes |
| | treatment | Energy density | — | 18 | 90 | — | 18 | 90 |
| | | (kJ/m²) | | | | | | |

| | Vacuum vapor deposition | | Optool DSX (after removal of solvent) was vapor- | | | | | |
|---|---|---|---|---|---|---|---|---|
| | | | deposited at 270° C.: film thickness of 10 nm) | | | | | |
| Evaluation | Water contact angle | 0 | 115.3 | 114.8 | 115 | 114 | 113.3 | 112 |
| | (degrees) after the | 2 | 116.1 | 111.6 | 111.9 | 114 | 112.5 | 114 |
| | number of times of | 5 | 113.2 | 110.5 | 111.7 | 109 | 111 | 113.8 |
| | abrasion operations | 10 | 109.5 | 113.3 | 112.7 | 92.7 | 110 | 112 |
| | (×10³ times) | 20 | 108.4 | 110.8 | 113.2 | 47.8 | 109.1 | 111.4 |
| | | 30 | 104.4 | 110.4 | 115.1 | | 109.8 | 111.7 |
| | | 40 | 111.9 | 109.5 | 114.3 | | 94 | 111.1 |
| | | 50 | 96.8 | 109.7 | 114.6 | | 96.7 | 109 |
| | | 60 | 96.7 | 111.3 | 114.1 | | 74 | 101.4 |
| | | 70 | 91.3 | 111.3 | 114.1 | | | 99.2 |
| | | 80 | 88.4 | 110.7 | 115.7 | | | 84.5 |
| | | 90 | 90.6 | 111 | 113.3 | | | 80.2 |
| | | 100 | 111.5 | 110 | 113.3 | | | |

In the case of the antifouling film-coated substrates 3 in Ex. 2 and 3 wherein in the atmosphere treatment, the plasma treatment was carried out at the same time as the atmosphere treatment, the water contact angle was not substantially lowered even after abrasion operations of 100,000 or more times. Also in the case of the antifouling film-coated substrate 3 in Ex. 1 wherein only the atmosphere treatment was carried out without carrying out plasma treatment in the atmosphere treatment step, the water contact angle substantially equal to the antifouling film-coated substrate 3 in Ex. 6 wherein only the plasma treatment was carried out, was obtained.

Whereas, in each of Ex. 4 to 6, the water contact angle was distinctly lowered in the number of abrasion operations far smaller than 100,000 times.

### INDUSTRIAL APPLICABILITY

According to the present invention, it is possible to provide an antifouling film-coated substrate having a fluorinated organic silicon compound coating film, which is excellent in antifouling properties as it has water repellency, oil repellency, etc. and which is excellent also in abrasion resistance whereby deterioration in the antifouling properties against e.g. repeated wiping operations, is prevented, and a process for its production. Such an antifouling film-coated substrate is useful particularly for a touch panel to be used for a smart phone, a tablet PC, etc., a display, an optical element or a sanitary appliance.

This application is a continuation of PCT Application No. PCT/JP2012/083351, filed on Dec. 21, 2012, which is based upon and claims the benefit of priority from Japanese Patent Application No. 2011-287484 filed on Dec. 28, 2011. The contents of those applications are incorporated herein by reference in their entireties.

### REFERENCE SYMBOLS

1: transparent substrate, 1a: film-forming surface of the transparent substrate, 2: antifouling film, 3: antifouling film-coated substrate, 10: humidifying device, 11: heating container, 12: piping, 13: variable valve, 14: supply section, 15: heater, 20: plasma treatment device (LIS), 21: slit opening, 22: ion beams, 23: permanent magnet, 24: anode, 25: cathode, 26: gas supply port, 27: discharge power source, 30: film-forming apparatus, 31: pre-chamber, 32: vacuum chamber, 33: substrate take-out chamber, 34: transportation means, 40: vacuum vapor deposition device, 41: heating container, 42: piping, 43: manifold, 44: variable valve, 45: film thickness meter

What is claimed is:

1. A process for producing an antifouling film-coated substrate comprising a transparent substrate and a fluorinated organic silicon compound coating film formed thereon, which comprises
an atmosphere treatment step of exposing a film-forming surface of the transparent substrate on which the fluorinated organic silicon compound coating film is to be formed, to at least a moisture-containing atmosphere, and
a film-forming step of applying and reacting, after the atmosphere treatment step, a composition containing a fluorinated hydrolysable silicon compound on the film-forming surface to form the fluorinated organic silicon compound coating film.

2. The process for producing a substrate with an antifouling film according to claim 1, wherein the water vapor pressure in the above atmosphere is more than 0.002 Pa.

3. The process for producing an antifouling film-coated substrate according to claim 1, wherein the water vapor pressure in the above atmosphere is at least 0.005 Pa.

4. The process for producing an antifouling film-coated substrate according to claim 1, wherein the atmosphere treatment step includes a step of exposing the film-forming surface to the above atmosphere for at least 5 seconds.

5. The process for producing an antifouling film-coated substrate according to claim 1, wherein the atmosphere treatment step includes a step of exposing the film-forming surface to the above atmosphere and at the same time, subjecting the film-forming surface to plasma treatment with an oxygen gas plasma at an energy density of at least 10 kJ/m².

6. The process for producing an antifouling film-coated substrate according to claim 1, which further includes, after the atmosphere treatment step, a plasma treatment step of subjecting the film-forming surface to plasma treatment with an oxygen gas plasma at an energy density of at least 10 kJ/m².

7. The process for producing an antifouling film-coated substrate according to claim 1, which has the atmosphere treatment step after a plasma treatment step of subjecting the film-forming surface to plasma treatment with an oxygen gas plasma at an energy density of at least 10 kJ/m².

8. The process for producing an antifouling film-coated substrate according to claim 5, wherein the plasma treatment is irradiation treatment with oxygen ion beams by a linear ion source.

9. The process for producing an antifouling film-coated substrate according to claim 5, wherein the energy density in the plasma treatment is from 10 to 100 kJ/m².

10. The process for producing an antifouling film-coated substrate according to claim 1, wherein the transparent substrate is a glass substrate.

11. An antifouling film-coated substrate obtainable by the process as defined in claim 1.
